(19) United States
(12) Patent Application Publication
(10) Pub. No.: US 2017/0140375 A1
(43) Pub. Date: May 18, 2017

(54) System and Method for Permissioned Distributed Block Chain

(71) Applicant: Michael Kunstel, Zurich (CH)

(72) Inventor: Michael Kunstel, Zurich (CH)

(21) Appl. No.: 14/941,656

(22) Filed: Nov. 15, 2015

(51) Int. Cl. G06Q 20/40; G06F 21/60; G06F 21/62

(52) U.S. Cl. CPC G06Q 20/40; G06F 21/6218; G06F 21/602

(57) ABSTRACT

The invention is a method for providing a permissioned distributed ledger to a requesting client, and comprises the steps of: receiving a client request for a specified distributed ledger; retrieving the specified distributed ledger from one of a document server or a computer-readable storage medium; associating client access permission criteria with the distributed ledger; performing at least one of a filtering, an obfuscation, and an encryption to produce a modified distributed ledger in conformance with the client permission criteria; and sending the modified distributed ledger to the client.

### FIELD OF THE INVENTION

The present invention relates to a method and system of providing selective access to data contained in ledger entries and, in particular, to a method of restricting access to sensitive ledger entries by means of utilizing obfuscation, summarization, and/or encryption techniques.

### BACKGROUND OF THE INVENTION

Distributed ledgers have been known in the art as digital record of facts, such as groups of transactions and ‘who-owns-what’. The digital record of facts are shared between many parties with cryptographic signatures, such as hashes, as a way of ensuring that information within the ledger has not been altered. While methods for confirming a new entry into a distributed ledger are many and varied, little research and attention has been placed on controlling who has access to particular records within a distributed ledger.

The distributed ledgers are often implemented using blockchains, which are conceptually blocks of data containing a group of facts. A distributed ledger entry may notationally contain any form of digital information. For example, the ledger entry may contain transactions, current state of accounts, computer programs, and text documents. As any form of data may be placed within a distributed ledger, it may be that the distributed ledger contains information not intended to be shared with other parties. Sharing of secret or confidential information may need to be done in such a way that only expressly allowed parties can receive or decipher the information.

A unique mathematical function known as a “hash function” can take the current blockchain data, and a previous block hash, and create a new hash value that uniquely identifies the current position of the block in the distributed ledger. The new hash value mathematically protects a current block of data from alteration or modification because any subsequent change performed on the previous block will change the new hash value. Such cryptographic techniques have been developed in the past and have been successful in maintaining data confidentiality to an extent. Implementations such as used in BITCOIN work on a consensus mechanism; that is, once everyone agrees on the data present in a new block, a mathematical hash ensures that the new block and previous block entries cannot be tampered with.

While such conventional implementations as BITCOIN allow any party to possibly author a new block by creating a new hash value, other implementations can be more restrictive. There have been improvements in such processes where other distributed ledger systems allow only a small group of trusted parties to create a new block, signing a new block with a “digital signature” to prove the author of the block. In these systems, a hash function is also used to chain the entries to guarantee that any new block and its previous blocks cannot be modified. While a great deal of attention has been focused on methods for creating new blocks and sharing this data with many parties, little if no research has been done in processes for selectively sharing data within a distributed ledger.

In European Patent EP0908810 B1, for example, there is disclosed a system for transferring blocks of program information between a secure circuit and an external storage device. The program information is communicated in block chains for more robust encryption, execution obfuscation, and the reduction of authentication data overhead. The system is basically an encryption of data in external memory but does not, however, cover selective encryption of distributed ledger or block chain based entries.

In U.S. Pat. No. 6,941,459, issued to Hind, there is disclosed a method, system, and computer program product for selectively encrypting one or more elements of a document using style sheet processing. Each document element specifies a different security policy, such that the different elements of a single document can be encrypted differently, while some elements remain unencrypted. The key distribution material enables a document to be encrypted for decryption by an audience that is unknown at the time of document creation.

The Hind system enables access to the distinct elements of a single encrypted document to be controlled for multiple users and/or groups of users. The usage of style sheets to modify XML documents is a well-known concept, and creating an encryption translation of parts of the XML document is a specific implementation of this concept. However, the Hind system does not address the issue of entries in distributed ledgers and blockchains which append only data structures that contain a collection of cryptographically-chained entries.

There are other systems, such as disclosed in U.S. Pat. No. 7,809,868, issued to Mu, where a storage system filter provides protocol-aware filter operations that avoid I/O blocking or calling thread holding. The Mu filter framework includes a filter controller that handles request and response calls to filters that are registered with the filter framework. Filters may be loaded and unloaded in a consistent state, and the filter framework provides services for the filters for common functions. Such prior art focuses on low-level file system access providing for non-locking of an operating systems disk while performing filtering.

U.S. Pat. No. 8,255,871 provides for computer implemented methods for software application that connects to another software application “source software” and generates metadata in a common format which makes reporting easier by working with a common format. However, such system of production of metadata is entirely different from that used in the present invention because the present disclosed invention focuses on using metadata to restrict access rather than creating metadata.

Published U.S. Application No. 20140279384 describes methods, systems, and computer program products for monitoring financial risks using a quantity ledger. A corrective action is taken if the risk is too large. However, such arts do not specifically relate to filtering or transforming the output from the ledger entry. There are inventions which relate to retrieving files by splitting the request over multiple sources (slice servers) which is a kind of load balancing from multiple sources. This is disclosed in Published U.S. Application No. 20100023524. However, none of the references disclosed above provide such advanced technology for maintaining encrypted data in block chains as well as filtering, obfuscation and sharing of data entries.

Although a great deal of attention has been focused on methods for creating new blocks, and sharing this data with many parties, what is needed is a method for selectively sharing data when distributing a distributed ledger.

### BRIEF SUMMARY OF THE INVENTION

In one aspect of the present invention, a method for providing a permissioned distributed ledger to a requesting client comprises: receiving a client request for a specified distributed ledger; retrieving the specified distributed ledger from one of a document server or a computer-readable storage medium; associating client access permission criteria with the distributed ledger; performing at least one of a filtering, an obfuscation, and an encryption to produce a modified distributed ledger in conformance with the client permission criteria; and sending the modified distributed ledger to the client.

In another aspect of the present invention, a method for modifying a distributed ledger for a requesting client comprises the steps of: retrieving the distributed ledger from one of a document server or a computer-readable storage medium; associating client access permission criteria with the distributed ledger; and encrypting at least one of a ledger header, a ledger body, and a ledger footer in the distributed ledger to produce a modified distributed ledger in conformance with the client permission criteria.

In yet another aspect of the present invention, a network permissioning system comprises: a computer-readable storage medium having stored therein access permission criteria for a plurality of clients, and a plurality of distributed ledgers; an originating workstation for receiving client requests for the distributed ledger, the workstation including a processor functioning to execute a permissioning system application which filters, obfuscates, transforms, and/or encrypts a requested distributed ledger before sending a modified distributed ledger to a client device.

The additional features and advantage of the disclosed invention is set forth in the detailed description which follows, and will be apparent to those skilled in the art from the description or recognized by practicing the invention as described, together with the claims and appended drawings.

### BRIEF DESCRIPTIONS OF THE DRAWINGS

The foregoing aspects, uses, and advantages of the present invention will be more fully appreciated as the same becomes better understood from the following detailed description of the present invention when viewed in conjunction with the accompanying figures, in which:

FIG. 1 is a diagrammatical diagram of a network permissioning system, in accordance with the present invention;

FIG. 2 is a diagrammatical representation of a distributed ledger, showing a header and a ledger body.

FIG. 3 is diagrammatical representation of a distributed document including a header, a ledger body and encrypted data sections where one of the encrypted data sections is a new entry;

FIG. 4 is a diagrammatical representation of a distributed document including metadata stored in a block header, as a single entry or data section in the block body, or as a number of optional separate metadata entries against one or more of the data sections;

FIG. 5 is a diagrammatical representation of a block including a block header, a block footer, and a block body including data sections, the block header having an optional permissioning field including a list of roles, groups, and/or other data signifying with whom one or more of the data sections may be shared;

FIG. 6 is a diagrammatical representation of a virtual database with an entry written to the distributed ledger of FIG. 3 as the new entry;

FIG. 7 is a flowchart illustrating a method for placing an applicant on a document distribution list and assigning permission parameters to the applicant, in accordance with the present invention; and

FIG. 8 is a flowchart illustrating a method for sending a requested document to a client, in accordance with the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention. This invention covers processes for controlling the sharing and replication of distributed ledger entries between multiple parties and, in particular, the processes of filtering, obfuscation, and encryption of distributed ledger entries. The present invention also includes the marking of distributed ledger entries so as to allow others to perform access control or to ascertain the subject of the ledger data, without exposing the data itself.

This invention further covers using access rules to manage the filtering, obfuscation and encryption of distributed ledger entries or data sections. A distributed ledger entry may notionally contain any form of digital information. For example, the ledger may contain financial transactions, current state of accounts, computer programs or code, and text documents. As any form of data may be placed within a data section in the distributed ledger, the distributed ledger may contain information not intended to be shared with other parties.

A number of definable filtering, obfuscation, transformation, and encryption steps may be configured to be applied for particular counterparties and peers. As understood by one skilled in the relevant art, and as used herein, a distributed ledger, or block-chain, representation includes one or more data sections that are effectively related to previous versions of the corresponding data sections, the relationship being a chained methodology using a hash. The use of a hash typically includes the application of digital signatures to prove the author of a block. The use of a hash function provides integrity for the distributed ledger data and serves to protect the block(s) from alteration.

In accordance with the present invention, selective sharing and access to ledger entries may be provided using rules and methods that are not taught in the current state of the art. Systems of distributed ledgers or block chain mechanisms are often implemented by creating data blocks consisting of two parts, a header and the body. The header details information such as: (i) time, (ii) a previous hash value, and (iii) the hash of the body. The ledger body may include one or more segments of digital information.

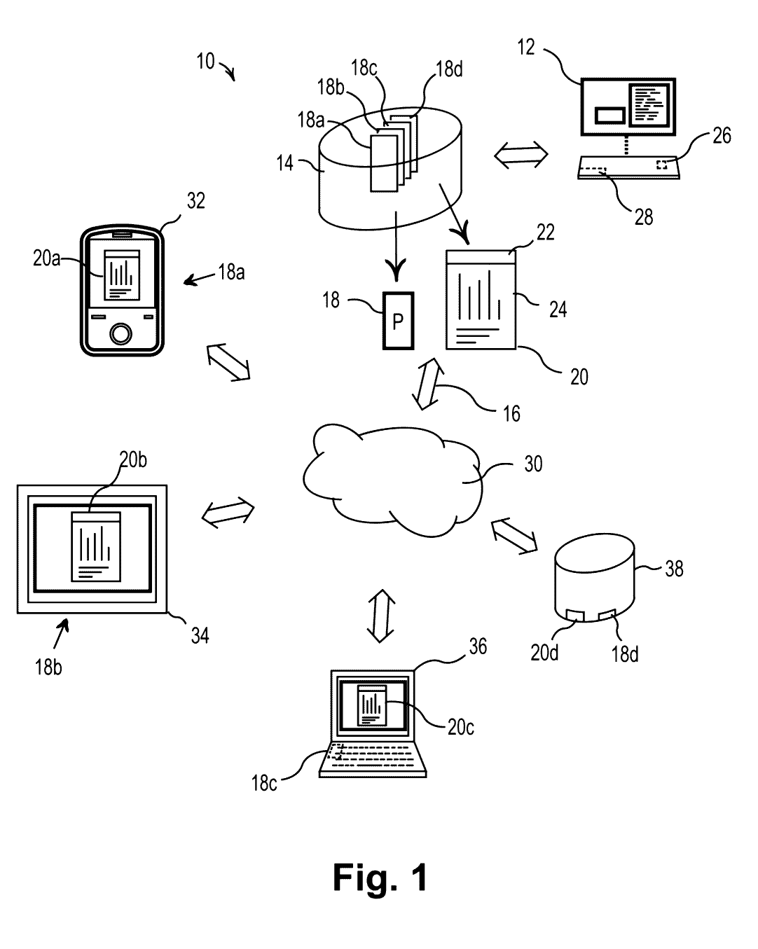

FIG. 1 is a diagram of a network permissioning system 10 as may be utilized for executing a method for transmitting permissioned distributed ledger data (e.g., a block chain), in accordance with the present invention. Ledger data may be pushed, uploaded, or otherwise sent to clients requesting the ledger data by an originator of the ledger data or an administrator of the network permissioning system 10. The ledger data originator and the system administrator may operate an originating work station 12 to select a distributed ledger 20 stored in a document server 14, or other computer-readable storage medium, and make available the distributed ledger 20, or a modified version, to users or clients via a communication link 16 connected to the Internet 30.

A processor 26 in the work station 12 functions to execute a permissioning system application 28 which filters, obfuscates, transforms, and/or encrypts the distributed ledger 20 before sending the modified version to the user or client. The permissioning can be defined as available per distributed ledger, per block, and/or per entries within the block. The permissioning system defines access control for users through various methods and a number of definable filtering, obfuscation, transformation and encryption steps may be configured to be applied for particular counterparties and peers.

The disclosed method includes an initial step of retrieving client access permission criteria 18 stored in the document server 14 in accordance with the disclosed permissioning system that limits client access to allowed data information in the requested ledger data. A client device such as, for example, a mobile communication device 32, a computer tablet 34, a laptop 36, or a remote client server 38, has assigned to the client device client access permission criteria 18. That is, access permission criteria 18a related to the mobile communication device 32, for example, may differ from access permission criteria 18b related to the computer tablet 34, and may also differ from access permission criteria 18c related to the computer laptop 36, and may further differ from access permission criteria 18d related to the remote client server 38, as explained in greater detail below.

The distributed ledger 20, comprising a ledger header 22 and a ledger body 24, may be managed by a single originator operating the originating work station 12. Alternatively, the distributed ledger 20 may be managed by a known group of parties in possession of the ledger data. In either case, the objective is to send secret or otherwise confidential information from the document server 14 to clients, with the stipulation that the ledger data must be only selectively shared among the clients. That is, a particular client will have pre-defined access to the distributed ledger 20, in conformance with the corresponding, assigned access permission criteria 18.

The data in the ledger body 24 may be encrypted upon entry or exit of the distributed blockchain, with decryption keys being made selectively available to clients. depending on permissioning rules explained in greater detail below. In the example provided, the access permission criteria 18a allows the client using the mobile communication device 32 to view a modified ledger document 20a, which may provide the same or less information than the original distributed ledger 20 sent by the originator or by the group of parties in possession of the ledger data. Similarly, the access permission criteria 18b may restrict the client using the computer tablet 34 to only a modified ledger document 20b, and the access permission criteria 18c may allow the client using the laptop 36 to view only a modified ledger document 20c. The client accessing the database in the remote client server 38 may similarly have access to only a modified ledger document 20d in place of the original ledger document 20, as determined by the access permission criteria 18d.

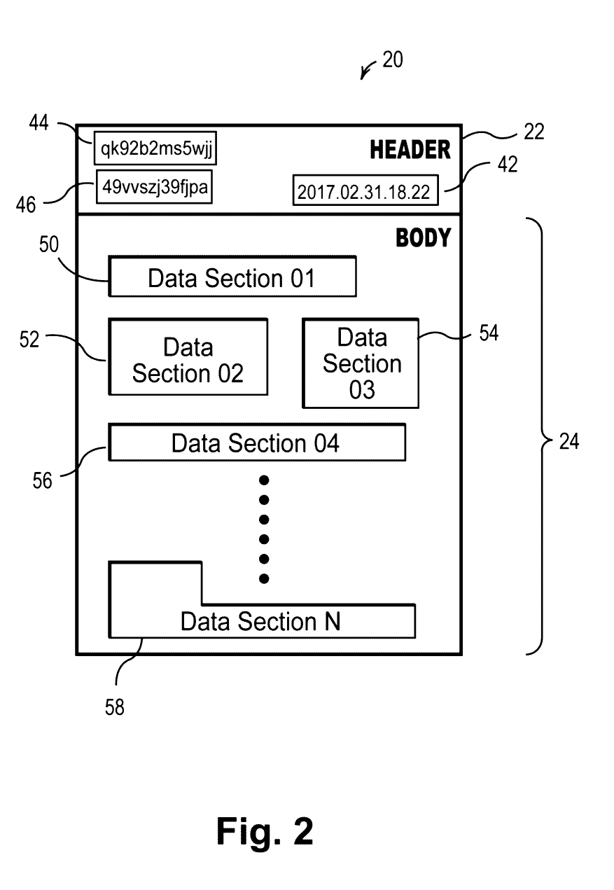

FIG. 2 is a diagrammatical representation of the distributed ledger 20, showing the header 22 and the ledger body 24. In the distributed ledger 20 (e.g., a block-chain), the header 22 may detail ledger information such as date/time 42, a previous hash value 44, and a hash 46 of the ledger body 24. The header 22 is thus typically small in size because of the modest amount of header data present. In comparison, the ledger body 24 typically includes extensive digital information, and makes up the bulk of the data provided in the distributed ledger 20. Although a block-based distributed ledger 20 is shown in the illustrative example, it should be understood that the disclosed method is equally applicable to non-block-based distributed ledgers.

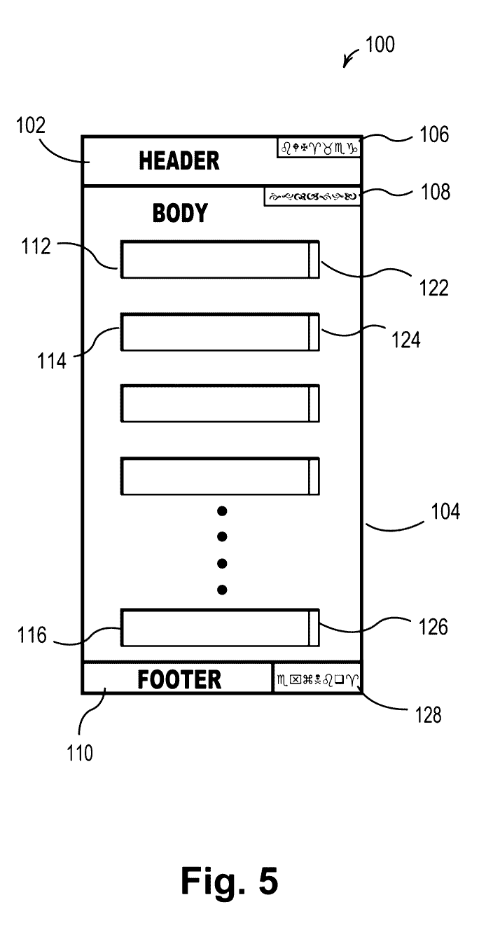

The extensive digital information contained in the ledger body 24 is represented in the illustration by a plurality of data sections 50-58. The data sections 50 and 56 may be viewed as rows of data, and the data sections 52 and 54 may be viewed as columns of data. As described in greater detail below, one or more of the data sections 50-58 may be available to a particular client device 32-38, depending on the access permission criteria 18 assigned to that client. As stated above, the distributed ledger provided to a client is modified in conformance with the client permission criteria. In an exemplary embodiment, the permissioning system may segregate client access rights between the header 22, the ledger body 24, and an optional ledger footer 110, shown in FIG. 5.

In an exemplary embodiment, referring to FIG. 2, the header 22 may be more openly shared, whereas the ledger body 24, which may contain block data, can be shared on a case-to-case basis. Access and sharing may be allowed within a block body such that one or more data sections 50-58 may be filtered for access. Permissioning rules can be set up to apply to specific clients, such as particular users, particular user groups, particular companies or organizations, particular networks, and any client in the possession of a particular token or key, for example. One of the permissioning methods of controlling access includes the feature of defining separate access rights between the header 22 and the data or ledger body 24.

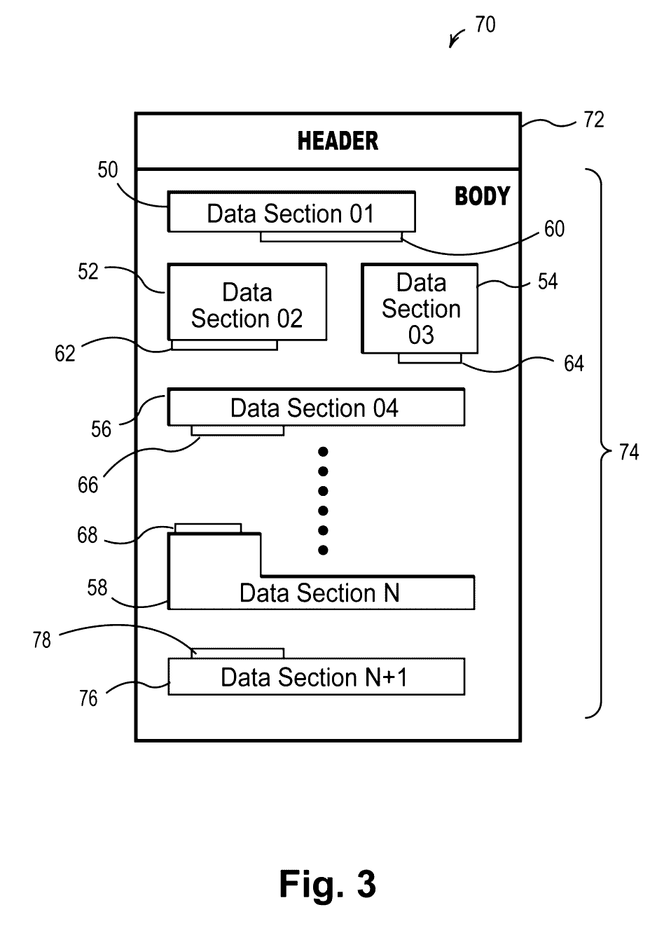

In another aspect of the invention, multiple hash values (for the header and for the body as well) may be included to cover different ledger data portions that may be shared selectively with other users. As shown in FIG. 3, a distributed document 70 includes a header 72, and a ledger body 74 having encrypted ledger data sections 50-58. Each of the data sections 50-58 has an associated, respective hash 60-68, whereby selected data sections are restricted from view by a client who does not possess the corresponding decryption key.

It can be appreciated that one of more of the encrypted data sections 50-58 may be available to a particular client having one or more decryption keys in the associated access permission criteria 18. This can be done at the specific request of a client to have access to, for example, an unencrypted data section 55. Or, the permission rules for the specific client can automatically allow the client to view the unencrypted data section 55 without requiring a request from the client. Alternatively, the client could be given a decryption key for the encrypted data section 55, automatically or by request. When a new entry, an encrypted data section 76 with a corresponding hash 78, is added to the ledger body 74, the client may not have automatic access, as is the case for the unencrypted data section 55. In this case, the client could specifically ask for the decryption key for the encrypted data section 76 if access were desired.

Alternatively, there may be separate access rights between the header 72 and the ledger body 74. Block headers may have a more open sharing permission, whereas data in a block body may be shared on a case-by-case basis with different counterparties. Access and sharing rights can be defined for entries within the block body, such that sections of a distributed ledgers block may individually permissioned and decrypted. Multiple hash values can be included with the header 72 to cover different sharable representations of the ledger body 74. One hash value may be provided as a hash of unencrypted data, another hash value may be provided for the encrypted version of the ledger data, and another hash value may be provided for a reduced or obfuscated representation of the ledger data. As can be appreciated by one skilled in the art, a data section can be filtered to: (i) allow access by a first requesting client, and (ii) deny access by a second requesting client.

A plurality of different hashes, or multiple hash values, may be included in the ledger body 74, such that a ledger body 74 containing many data sections can be selectively decrypted and filtered. For example, a ledger body 74 containing a hundred data sections (i.e., N=100), can be selectively decrypted and filtered, with each data section having a unique assigned hash. The data sections can then be filtered out while keeping only the hashes of the data sections 50-58. The block header 72 may then comprise a hash of all the hashes within the ledger body 74.

In an exemplary embodiment of the invention, permissioning metadata and content metadata may be used for selective access and sharing of the ledger data contained in one of more of the data sections. The addition of metadata compliments the permissioning system by indicating the permissions required to share this ledger data. Inclusion of permissioning metadata can also be done on blocks or entries within a distributed ledger containing derived information on the ledger data itself. In this way, the permissioning method can provide indications as to the data contained within a block, without giving permission to access the data itself.

The addition of metadata to a distributed ledger may compliment the hash aspect of a permissioning system. Consider a scenario in which a known group of counterparties share the same distributed ledger. The originator of the ledger data may wish to restrict dissemination of the ledger data within the group of counterparties, and this can be done by using the additional limitation provided by the metadata. For example, a publisher of information, named ‘Alice’ may prefer that not all counterparties have certain identified information, and wishes to control the counterparties which will share the information. Counterparty ‘Bob’ has received the entry published by Alice and notes its metadata. Given the criteria, Bob is not allowed to share that data with ‘Charles’.

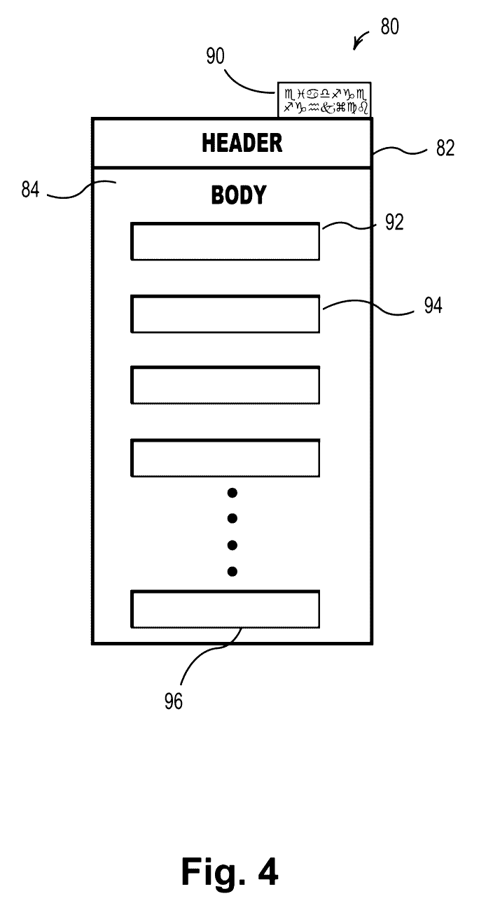

The metadata may be stored anywhere in an entry of a distributed ledger 80, shown in FIG. 4. Metadata can be stored in the block header 82, as a single entry or data section 92 in the block body 84, or as a number of optional separate metadata entries against one or more of the data sections 92-96. Permission criteria 90 may be set on the distributed ledger 80 as a whole. When the permission criteria 90 is filled in with data, the data may comprise a list of roles, groups, or other data signifying the clients with whom the data may be shared.

In an exemplary embodiment, a block 100 may include a block header 102 with an optional permissioning field 106, as shown in FIG. 5. In an exemplary embodiment, the block 100 may include a ledger footer, or trailing block footer 110, with an optional permissioning field 128. The footer 110 can be included in the block 100 with the block header 102, or may be used in place of the block header 102. The distinction is merely in the position of the block header 102 and/or the block footer 110 relative to data sections 112 through 116.

In the example provided, the permissioning field 106 comprises a list of roles, groups, and/or other data signifying with whom one or more of the data sections 112 through 116 may be shared. The block body 104 may further contain an optional permissioning field 108, similar in structure to the permissioning field 106 in the block header 102. For certain applications, one or more of the data sections 112-116 in the block body 104 may contain respective optional permissioning fields 122 through 126. The permissioning fields 122-126 may be similar in structure to the permissioning field 106 or to the permissioning field 108.

The multiple permissioning fields 106, 108, and 122 through 126 are preferably invoked in a specified priority or sequence, from “least precise” (e.g., most broad), to “most precise” or “fine grained.” For example, access information provided in the permissioning field 106 should be used first. Permissioning information in the permissioning field 108 is to be used second. The permissioning information in the permissioning field 108 in the block body 104 would be used to either replace or restrict the permissioning field 106 and/or the permission criteria 90, shown in FIG. 4, if present. In turn, the permissioning fields 122-126 may be used to further restrict or replace the less precise permission criteria in the permission fields 106 and 108.

As an example of the priority sequence described above, consider a block body having access information requiring that a plurality of entries in a distributed ledger can be shared with only specified members of a group X and a group Y. Suppose that the ledger body contains a number of entries with blank permission details, but where one entry Z includes an access restriction such that clients from group Y have access only after a specified date. In this case, all entries except for entry Z are available to clients from group X and group Y. The remaining entry Z will not be given to client from group X. A client from the group Y will have access to the remaining entry Z after the specified date.

In another aspect of the invention, “fine grained” permissioning can be done where certain fields may be obfuscated or filtered out on entry or exit to the distributed ledger block chain. Such decryption keys on entry/exit of ledger data may be selectively made applicable to particular users. For example, this may include the obfuscation via hash, or removal, of a client's name or other sensitive data, from a reported trade. This method of permissioning might be supplemented by including a hash for the original data along with the hash of the filtered or modified data.

Accordingly, the present invention functions to provide ledger data access to selective clients. The contents of distributed ledgers and successive block chains may be filtered by using a metadata process, where access rights may be defined separately for a header and a ledger body. This methodology provides for greater confidentiality of ledger data, and provides convenience in sharing the corresponding block chains. For example, a financial institution may place all of the day's stock trades within its distributed ledger. Releasing of this information to unauthorized parties can result in civil and criminal legal ramifications. By encrypting the stock trades, the financial institution can restrict improper dissemination of the ledger data as well as the information present in the block chains.

Under some circumstances, the financial institution may be required to share the trades executed on one or more exchanges to a particular regulator. The regulator may specify that the information must be divulged within a specified time period, or may require a form of proof to be delivered either immediately or on the same business day. For this situation, the financial institution may allow the transfer of certain ledger data to the requesting regulator. The ledger data provided to the regulator may comprise only the block headers of any blocks deemed to be sensitive, but the block bodies themselves would not be provided to the regulator. This process ensures non-divulgence of sensitive original ledger data while allowing access to selected encrypted or coded data.

In the same example, it may be a requirement that all trades be sent to the clearing house immediately. A separate permission rule ensures that the block header and the block body are immediately available to the clearing firm, upon request. This action requires selective permission rules, as described above. Transferal of the headers ensures that the block chain remains unmodified, without divulging what ledger data was present in the block chain. After a specified period of time, the access rule may allow the regulator, or other counterparty, to access some or all of the all data on the original trades. This process can be implemented by the relevant decryption keys to the requesting regulator, either directly or by a subsequent transmittal of an unencrypted distributed ledger. Alternatively, the requisite keys may be provided directly via conventional transmittal means, such as file transfer protocol (FTP), for example.

While an implementation such as Bitcoin allows various parties to author a new block in the blockchain, other implementations can be more restrictive. The distributed ledger system may allow only a small group of trusted parties to create a new block, by signing a new block with a “digital signature” to prove the author of the block. In these systems, a hash function is similarly used to chain the successive entries to guarantee that any new block, and previous blocks, cannot be modified without detection. As is understood in the relevant art, cryptographic digital signatures use hashes at their core. Accordingly, the application of a digital signature can be used in place of a hash, in accordance with the present invention.

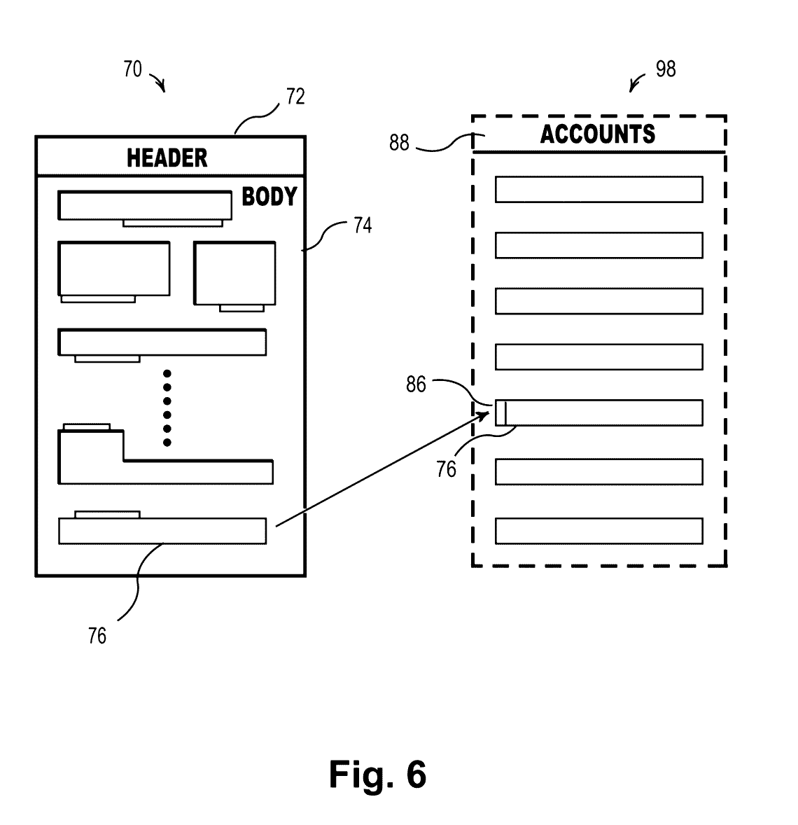

The network permissioning system 10 can also provide for limited distribution of sensitive information for applications other than distributed ledgers. FIG. 6 is a diagrammatical representation of a virtual database table 98 having an “updated” entry 76, which has been mapped from the “new entry” data section 76 in the distributed ledger 70. In the virtual database table 98, the entry 76 may thus be selectively encrypted 86 at a table level, a row level, and/or a column level. The encryption of data section 76 as a ledger entry provides for encryption at the destination virtual database table 98. In the example provided, the virtual database table 98 has a header 88 labeled “Accounts” and includes a plurality of entries, some of which may be account balances for various clients, for example. The writing process ensures that the data section 76 entry in the distributed ledger 70 will have the “name” data field encrypted.

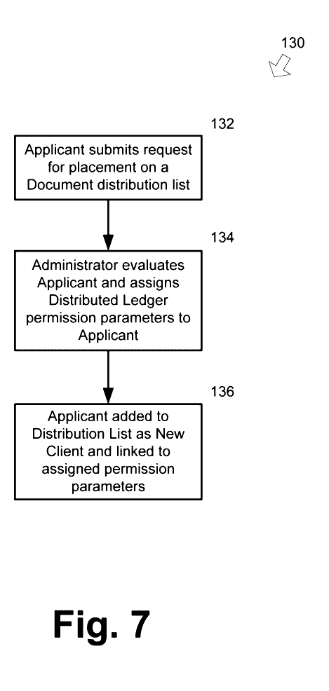

A potential client may submit a request to the administrator of the network permissioning system 10 to be placed on a list for receiving requested documents, such as the distributed ledger 20, at step 132 of a flow diagram 130 shown in FIG. 7. In an exemplary embodiment, the administrator may evaluate the client against predefined client standards established for the network permissioning system 10, at step 134. If the Applicant is accepted, one or more distributed ledger permission parameters are then assigned to the Applicant. The Applicant is then added to a distribution list as a new client qualified to receive specified documents, modified in accordance with the client permission parameters.

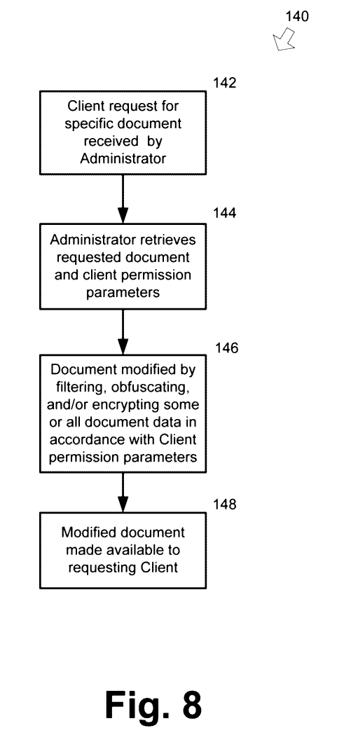

A flow diagram 140 in FIG. 8 shows a typical document request and delivery procedure. A client using the mobile communication device 32 may make a request to the administrator at the originating work station 12 of FIG. 1 for the distributed ledger 20, at step 142. The administrator retrieves or otherwise pulls up the distributed ledger 20 as well as the access permission criteria 18a associated with the client, at step 144. The distributed ledger 20 is filtered, obfuscated, and/or encrypted in accordance with the access permission criteria 18a to produce a modified distributed ledger 20a, at step 146. The modified distributed ledger 20a is then sent to the client using the mobile communication device 32, at step 148.

It is to be understood that the description herein is only exemplary of the invention, and is intended to provide an overview for the understanding of the nature and character of the disclosed system and method for permissioned distributed block chain. The accompanying drawings are included to provide a further understanding of various features and embodiments of the method and devices of the invention which, together with their description serve to explain the principles and operation of the invention.

What is claimed is:

1. A method for providing a permissioned distributed ledger to a requesting client, said method comprising the steps of:
receiving a client request for a specified distributed ledger;
retrieving said specified distributed ledger from one of a document server or a computer-readable storage medium;
associating client access permission criteria with said distributed ledger;
performing at least one of a filtering, an obfuscation, and an encryption to produce a modified distributed ledger in conformance with said client permission criteria; and
sending said modified distributed ledger to the client.

2. The method of claim 1 wherein said distributed ledger comprises a ledger body and at least one of a ledger header and a ledger footer.

3. The method of claim 2 further comprising modifying at least one of said ledger header, said ledger body, and said ledger footer in accordance with said client access permission criteria.

4. The method of claim 1 wherein said distributed ledger comprises at least one data section chained, by using a hash, to a previous version of said at least one data section.

5. The method of claim 4 wherein said distributed ledger further comprises a permissioning field having a list of roles and groups signifying with whom said data section may be shared.

6. The method of claim 4 wherein said distributed ledger further comprises permissioning metadata used for selective access and sharing of said ledger data contained in said at least one data section.

7. The method of claim 4 wherein said distributed ledger further comprises content metadata used for selective access and sharing of said ledger data contained in said at least one data section.

8. The method of claim 4 wherein said at least one data section comprises a member of the group consisting of a financial transaction, a current state of an account, a computer programs, a computer code, and a text document.

9. The method of claim 1 wherein said step of sending said modified distributed ledger comprises the step of making available said modified distributed ledger to the client via a communication link connected to the Internet.

10. The method of claim 4 wherein said at least one data section is filtered to allow access by a first requesting client and to deny access by a second requesting client.

11. A method for modifying a distributed ledger for a requesting client, said method comprising the steps of:
retrieving the distributed ledger from one of a document server or a computer-readable storage medium;
associating client access permission criteria with the distributed ledger; and
encrypting at least one of a ledger header, a ledger body, and a ledger footer in the distributed ledger to produce a modified distributed ledger in conformance with said client permission criteria.

12. The method of claim 11 wherein said step of encrypting comprises the step of including multiple hash values with said ledger header to cover different sharable representations of said ledger body.

13. The method of claim 11 wherein said step of encrypting comprises the step of assigning a hash to at least one data section in said ledger body.

14. The method of claim 11 wherein said step of encrypting comprises the step of defining separate access rights for the requesting client between said ledger header, said ledger body, and said ledger footer.

15. The method of claim 11 further comprising the step of providing a decryption key to the requesting client.

16. The method of claim 11 further comprising the step of mapping a data section in said ledger body to a virtual database table, said data section being selectively encrypted at one of a table level, a row level, and a column level.

17. A network permissioning system suitable for providing distributed ledger data to requesting clients, said system comprising:
a computer-readable storage medium having stored therein access permission criteria for a plurality of clients, and a plurality of distributed ledgers; and
an originating workstation for receiving client requests for the distributed ledger, said workstation including a processor functioning to execute a permissioning system application which filters, obfuscates, transforms, and/or encrypts a requested distributed ledger before sending a modified distributed ledger to a client device.

18. The network of claim 17 wherein said client device comprises one of a mobile communication device, a computer tablet, a laptop, or a remote client server.

19. The network of claim 17 wherein the distributed ledger comprises at least one data section chained, by using a hash, to a previous version of said at least one data section.

20. The network of claim 17 wherein the distributed ledger comprises permissioning metadata used for selective access and sharing of ledger data contained in data sections of the distributed ledger.
